(19) United States
(12) Patent Application Publication
(10) Pub. No.: US 2007/0270157 A1
(43) Pub. Date: Nov. 22, 2007

(54) System and Method for Tracking Position of a Mobile Unit Using Beacons in a Mobile Communication System

(76) Inventors: June Man Kim, Gyeonggi-do (KR); Noh Sang Park, Gyeonggi-do (KR)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/560,664

(22) PCT Filed: Jul. 23, 2004
(86) PCT No.: PCT/KR04/01851

§ 371 Date: Oct. 19, 2006

(30) Foreign Application Priority Data
Jul. 24, 2003 (KR) 10-2003-0050916

(51) Int. Cl. H04Q 7/20

(52) U.S. Cl. 455/456.1

(57) ABSTRACT

The present invention relates to a device for tracking the position of a mobile unit in a mobile communication system by using beacons, wherein each beacon has its own sub-coverage in the cell coverage of a base transceiver station (BTS). The present invention resolves the problem of the conventional network-based or handset-based position tracking methods. By using beacon information included in a Pilot Strength Measurement Message (PSMM) signal, the present invention increases the accuracy of position tracking to thereby improve the quality of supplemental services in the mobile communication system.

### TECHNICAL FIELD

The present invention generally relates to tracking position of a mobile unit in a mobile communication system, and more particularly to a system and a method for tracking position of a mobile unit by using a plurality of beacons. The beacons, each of which has a certain coverage, are installed within a cell coverage of a base station such that when a mobile unit comes into the coverage of a beacon, the current position of the mobile unit can be accurately determined by using information on the beacon.

### BACKGROUND ART

One of the conventional methods for tracking position of a mobile unit is a network-based positioning approach which uses specialized location equipment within the network to determine the location of a mobile unit. The other conventional method is a handset-based positioning approach which uses specialized electronics, such as a global positioning system (GPS), within the mobile unit.

The accuracy of positioning the mobile unit by the conventional methods, however, can he significantly compromised in metropolitan environments where local obstructions, such as large buildings, often disrupt signal reception. While moving through regions crowded with large buildings, the mobile unit oftentimes cannot receive signals from satellites for tracking position or pilot signals from neighboring base stations due to crowded environments. As shown in FIG. 1, the network-based positioning approach employs pilot signals from the neighboring base stations to track position of the mobile unit. The mobile unit must receive pilot signals from at least 3 neighboring base stations in order to accurately determine the position. In the metropolitan environment, however, it is practically impossible for the mobile unit to receive pilot signals from at least 3 neighboring base stations.

### DISCLOSURE OF INVENTION

### Technical Problem

This resulted in the significant degradation in the accuracy or determining the position of the mobile unit, which in turn adversely affected the quality of the location-based supplemental service in a mobile communication. The conventional methods simply could not satisfy the expectations of subscribers for the location-based service.

### Technical Solution

In order to address and resolve the problems of the conventional approaches, the present invention provides a system for tracking position of a mobile unit in a mobile communication system. The system comprises a plurality of beacons installed within a cell coverage of a base station, in which each beacon has its sub-coverage and transmits a pilot signal to the mobile unit in the sub-coverage. Further, a base station controller is provided for checking whether beacon information is included in a Pilot Strength Measurement Message (PSMM) signal upon receiving the PSMM signal from the mobile unit via a base transceiver station. The base station controller transmits position information including the beacon information if the beacon information is included in the PSMM signal. Such controller transmits neighbor list information on base transceiver stations adjacent to the mobile unit if the beacon information is not included in the PSMM signal. The system additionally comprises a position-tracking device for extracting information on the corresponding beacon from its database by using the position information upon receiving the position information including the beacon information from the base station controller. It then tracks/determines the position of the mobile unit by using the information on the corresponding beacon. Alternatively, the position-tracking device tracks/determines the position of the mobile unit by a conventional position-tracking method by using the neighbor list information on the adjacent base transceiver stations upon receiving the neighbor list information on the base transceiver stations adjacent to the mobile unit from the base station controller.

The present invention further provides a method for tracking the position of a mobile unit in a communication system including the mobile unit, beacons, base station controller aid position-tracking device. The method comprises: checking whether beacon information is included in a Pilot Strength Measurement Message (PSMM) signal when the base station controller receives the PSMM signal from the mobile unit; transmitting position information including the beacon information from the base station controller to the position-tracking device if the PSMM signal from the mobile unit contains the beacon information; and extracting information on the corresponding beacon from the database of the position-tracking system when the position-tracking system receives the position information including the beacon information from the base station controller and tracking/determining the position of the mobile unit by using the information on the corresponding beacon.

### Advantageous Effects

The system and the method for tracking position by using beacons in accordance with the present invention can improve the reliability and the accuracy of determining the position of the mobile unit. Such system and method can further improve the quality of the location-based supplemental services.

### BRIEF DESCRIPTION OF THE DRAWINGS

The above and other objects and features of the present invention will become apparent from the following description of the embodiments provided in conjunction with the accompanying drawings.

FIG. 1 is a schematic diagram for illustrating the conventional network-based positioning approach.

FIG. 2 is a schematic diagram of a system for tracking position by using beacons in accordance with the present invention.

FIGS. 3 to 6 illustrate configurations of beacons instated within a cell coverage of the base station shown in FIG. 2.

FIG. 7 is a flow chart showing a method for tracking position of a mobile unit by using beacons in accordance with an embodiment of the present invention.

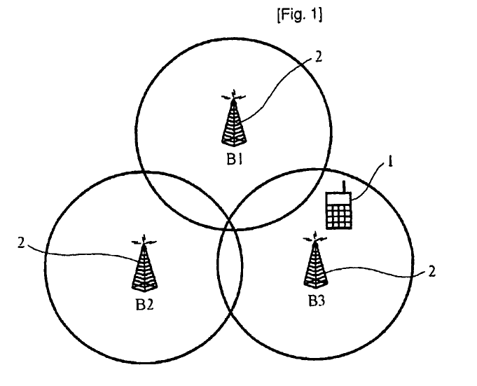

### BEST MODE FOR CARRYING OUT THE INVENTION

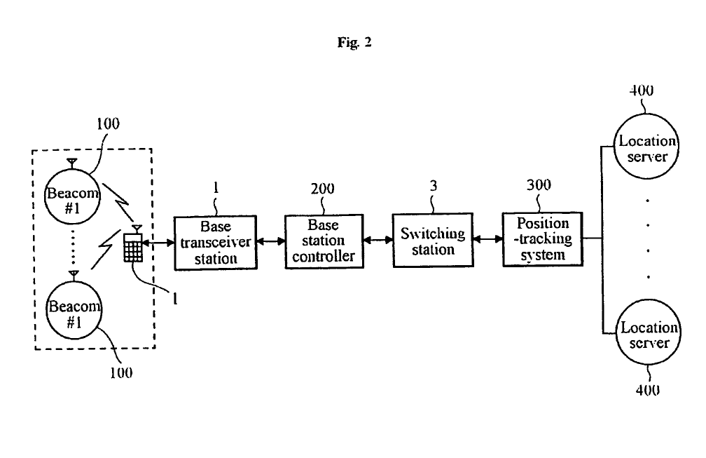

Referring yo FIG. 2, the system for tracking position by using beacons in accordance with the present invention comprises a plurality of beacons 100, a base station controller 200 and a position-tracking device 300 (which is commonly referred to as a position determination entity (PDE)).

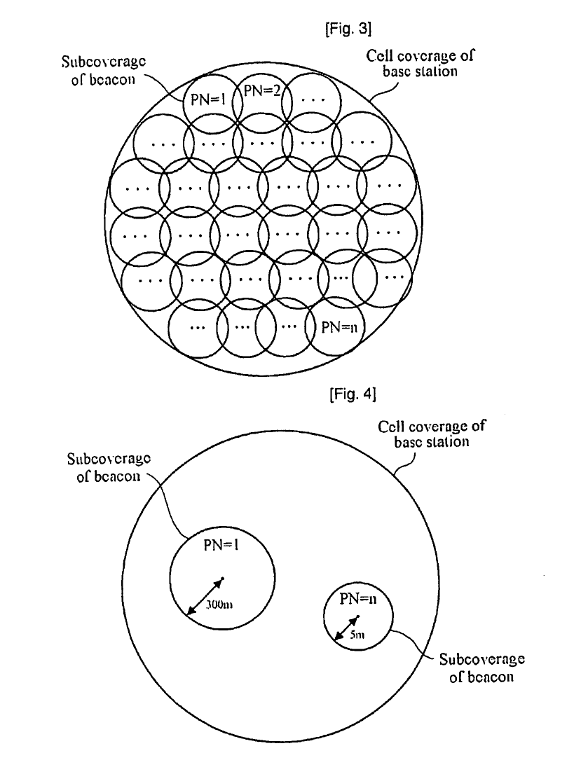

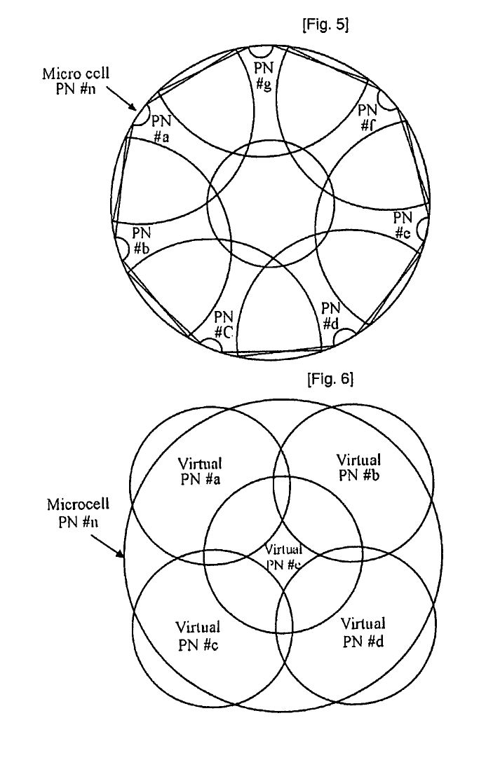

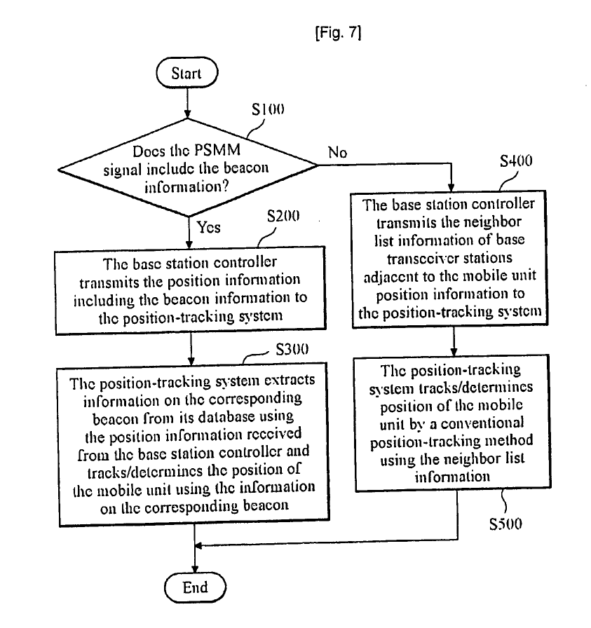

A plurality of the beacons 100 is installed in a cell coverage of a base station 2. Each beacon 100 has its own sub-coverage and transmits a pilot signal to a mobile unit located in its sub-coverage. The beacons 100, each of which has the same radius of sub-coverage, may be installed to cover the whole area of the cell coverage of the base station 2 as shown in FIG. 3. The beacons 100, each of which has a different radius of sub-coverage, may be installed to cover particular regions of the cell coverage of the base station 2 (shown in FIG. 4). The beacons may be installed as shown in FIG. 5 so that at least three virtual pilot signals are provided at regions having only one-way pilot signal within the cell coverage of the base station 2 to improve the tracking accuracy. Alternatively, the beacons may he installed at borders with adjacent base stations as shown in FIG. 6 so that two-way pilot signal can be provided at regions having only one-way pilot signal to guarantee the accuracy of tracking within the cell coverage. The configuration of the beacons 100 in the cell coverage of the base station 2 may be adjusted according to the local environments. The radius of the sub-coverage of the beacon 100 ranges from 5 m to 300 m, which can be adjusted by the power of the pilot signal.

The base station controller 200 transmits a Pilot Strength Measurement Message (PSMM) request to the mobile unit 1. It then checks whether the PSMM signal received from the mobile unit 1 during a transmission period of the PSMM signal includes the beacon information. If the PSMM signal contains the beacon information, then the base station controller 200 transmits the position information containing the beacon information to the position-tracking device 300 via the switching station 3. The position information transmitted from the base station controller 200 to the position-tracking device 300 includes pilot number (PN) information of the corresponding beacon 100, delay information representing a distance from the center of the corresponding beacon to the mobile unit 1, and time stamp information representing measurement time of the mobile unit 1.

When the PSMM signal received from the mobile unit 1 does not contain the beacon information, the base station controller 200 transmits the neighbor list information on base transceiver stations 2 adjacent to the mobile unit 1 to the position-tracking device 300 via the switching station 2.

When the position-tracking device 300 receives the position information containing the beacon information from the base station controller 200, the position-tracking device 300 extracts information on the corresponding beacon 100 from its database using the position information. Then, it tracks/determines the position of the mobile unit 100 through using the extracted information on the corresponding beacon 100. The information extracted from the database of the position-tracking device 300 includes latitude, longitude, coverage radius of the corresponding beacon and other information on environment of the corresponding beacon. The position-tracking device further transmits the information on the position of the mobile unit 1 to location servers 400.

When the position-tracking device 300 receives the neighbor list information on the base transceiver stations 2 adjacent to the mobile unit 100 from the base station controller 200, the position-tracking device 300 determines the position of the mobile unit 1 by using the neighbor list information according to the conventional position-tracking method. It then transmits the information on the position of the mobile unit 1 to the location servers 400.

Referring now to FIG. 7, a method for tracking position of a mobile unit by using beacons is described in accordance with an embodiment of the present invention.

At step 100, the base station controller 200 checks whether the PSMM signal received from the mobile unit 1 contains the beacon information.

When the PSMM signal received from the mobile unit 1 contains the beacon information, the base station controller 200 transmits the position information including the beacon information to the position-tracking device 300 at step 200. The position information transmitted from the base station controller 200 to the position-tracking device 300 includes pilot number (PN) information of the corresponding beacon 100, delay information representing a distance from the center of the corresponding beacon to the mobile unit 1, and time stamp information representing measurement time of the mobile unit 1.

At step 300, when the position-tracking device 300 receives the position information including the beacon information, the position-tracking device 300 extracts the information on the corresponding beacon from its database by using the position information. Then, the position-tracking device 300 determines the position of the mobile unit 1 through using the extracted information on the corresponding beacon 100. The information extracted from the database of the position-tracking device 300 includes latitude, longitude, coverage radius of the corresponding beacon and other information on environments of the corresponding beacon. The tolerance for the accuracy of positioning the mobile unit in accordance with the present invention is about 30 m, which is better than that of the conventional network-based approach or the handset-based positioning approach (e.g., 100 m).

When the PSMM signal received from the mobile unit 1 does not contain the beacon information, the base station controller 200 transmits the neighbor list information on base transceiver stations adjacent to the mobile unit 1, which is necessary to track position according to the conventional approach, to the position-tracking device 300 at step 400.

After receiving the neighbor list information from the base station controller 200, the position-tracking device 300 tracks/determines the position of the mobile unit 1 by using the neighbor list information. This is done by the conventional position-tracking method at step 500.

The information on the location of the mobile unit, which was determined through steps 100 to 500, is transmitted to the location servers 400 and can be used in various location-based supplemental services of the mobile communication.

### INDUSTRIAL APPLICABILITY

As described above, the system and the method for tracking position by using beacons in accordance with the present invention can enhance the reliability and the accuracy of tracking position. As such, the quality of the location-based supplemental services can be improved.

Furthermore, in accordance with the present invention, at least two-way pilot signal is provided by beacons at regions within the cell coverage of a base station where signals from the adjacent base stations is not present, that is, where only one-way pilot signal is present. This improves the accuracy of tracking position.

While the present invention has been shown and described herein with respect to the particular embodiments, those skilled in the art will recognize that many exchanges and modifications may be made without departing from the scope of the invention as defined in the appended claims.

1. A system for tracking position of a mobile unit in a mobile communication system, comprising
a plurality of beacons installed within a cell coverage of a base station, each beacon having its sub-coverage and transmitting a pilot signal to the mobile unit in the sub-coverage;
a base station controller for checking whether beacon information is included in a Pilot Strength Measurement Message (PSMM) signal upon receiving the PSMM signal from the mobile unit via a base transceiver station, the base station controller transmitting position information including the beacon information if the beacon information is included in the PSMM signal, the base station controller transmitting neighbor list information on base transceiver stations adjacent to the mobile unit if the beacon information is not included in the PSMM signal; and
a position-tracking device for extracting information on the corresponding beacon from its database by using the position information upon receiving the position information including the beacon information from the base station controller, the position-tracking device further tracking/determining the position of the mobile unit by using the information on the corresponding beacon, or for tracking/determining position of the mobile unit by a conventional position-tracking method by using the neighbor list information on the adjacent base transceiver stations upon receiving the neighbor list information on the base transceiver stations adjacent to the mobile unit from the base station controller.

2. The system of claim 1, wherein the radius of the sub-coverage of the beacon ranges from about 5 m to about 300 m.

3. The system of claim 1, wherein the position information transmitted from the base station controller to the position-tracking device includes pilot number (PN) information of the corresponding beacon, delay information representing a distance from the center of the corresponding beacon to the mobile unit, and time stamp information representing measurement time of the mobile unit.

4. The system of claim 1, wherein the information on the corresponding beacon which is extracted from the database of the position-tracking device includes latitude, longitude, coverage radius of the corresponding beacon and other information on environments of the corresponding beacon.

5. The system of claim 1, wherein each beacon has the same radius of coverage and a plurality of the beacons are instated uniformly to cover the whole area of the cell coverage of a particular base station.

6. The system of claim 1, wherein each beacon has different radius of coverage and a plurality of the beacons are installed at only particular regions within cell coverage of a particular base station to cover only the particular regions.

7. The system of claim 1, wherein a plurality of the beacons are installed so that virtual PN is provided toward inside the border of the cell coverage of a particular base station at regions within the cell-coverage of the particular base station where only one pilot signal is sensed.

8. The system of claim 1, wherein each beacon has the same radius of coverage and a plurality of the beacons are installed so that virtual PN is provided to a cell coverage of a particular base station and to a cell coverage of adjacent base stations at regions within the cell-coverage of the particular base station where only one pilot signal is sensed.

9. A method for tracking position of a mobile unit in a communication system including the mobile unit, beacons, a base station controller and a position-tracking device, the method comprising:
checking whether beacon information is included in a Pilot Strength Measurement Message (PSMM) signal when the base station controller receives the PSMM signal from the mobile unit;
transmitting position information including the beacon information from the base station controller to the position-tracking device if the PSMM signal from the mobile unit contains the beacon information; and
extracting information on the corresponding beacon from the database of the position-tracking device when the position-tracking device receives the position information including the beacon information from the base station controller, and tracking/determining the position of the mobile unit using the information on the corresponding beacon.

10. The method of claim 9, further comprising
transmitting neighbor list information on the base transceiver stations adjacent to the mobile unit to the position-tracking device if the PSMM signal received from the mobile unit does not contain the beacon information,
tracking/determining the position of the mobile unit by a conventional position-tracking method through using the neighbor list information when the position-tracking device receives the neighbor list information from the base station controller.

11. The method of claim 9, wherein the position information including the beacon information, which the base station controller transmits to the position-tracking system, includes pilot number (PN) information of the corresponding beacon, delay information representing a distance from the center of the corresponding beacon to the mobile unit, and time stamp information representing measurement time of the mobile unit.

12. The method of claim 9, wherein the information on the corresponding beacon, which is extracted from (he database of the position-tracking device includes latitude, longitude, coverage radius of the corresponding beacon and other information on environments of the corresponding beacon.

13. The method of claim 9, wherein the tracked information on the position of the mobile unit is employed in the location-based supplemental service of the mobile communication system.
